(19) United States
(12) Patent Application Publication
(10) Pub. No.: US 2024/0314611 A1
(43) Pub. Date: Sep. 19, 2024

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Jing Wang, Beijing (CN); Lan Chen, Beijing (CN)

(73) Assignee: NTT DOCOMO, INC., Tokyo (JP)

(21) Appl. No.: 18/576,603

(22) PCT Filed: Jul. 7, 2021
(86) PCT No.: PCT/JP2021/025693

§ 371 Date: Jan. 4, 2024

(51) Int. Cl. H04W 24/10

(52) U.S. Cl. CPC H04W 24/10

(57) ABSTRACT

A terminal according to an aspect of the present disclosure includes: a control section that controls mapping order of channel state information (CSI) fields included in a CSI report including information related to measurement of a plurality of transmission/reception points (TRPs), based on at least one of a substance of a parameter and a corresponding transport block (TB) index or TRP index; and a transmitting section that transmits the CSI report.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In NR, a user terminal (User Equipment (UE)) measures, based on a resource of a reference signal such as a channel state information reference signal (CSI-RS), a channel state, and feeds back (reports) the channel state information (CSI) to a network (for example, a base station).

For NR, it is under study that one or a plurality of transmission/reception points (TRPs) (multiple TRPs (multi-TRP (M-TRP))) perform DL transmission to a UE by using one or a plurality of panels (multiple panels). It is also under study that the UE performs UL transmission to the one or the plurality of TRPs by using the one or the plurality of panels.

However, in the NR specifications thus far, studies have not sufficiently been made on control of CSI reporting when the multiple panels/TRPs are used. For example, a known CSI priority does not take an account of the TRPs. Thus, with a known CSI priority used, CSI reporting cannot be appropriately performed for multiple TRPs, and this may cause throughput reduction or communication quality degradation.

In view of this, the present disclosure has one object to provide a terminal, a radio communication method, and a base station that enable appropriate control of CSI reporting even when a plurality of TRPs or panels are used.

### Solution to Problem

A terminal according to an aspect of the present disclosure includes: a control section that controls mapping order of channel state information (CSI) fields included in a CSI report including information related to measurement of a plurality of transmission/reception points (TRPs), based on at least one of a substance of a parameter and a corresponding transport block (TB) index or TRP index; and a transmitting section that transmits the CSI report.

### Advantageous Effects of Invention

According to an aspect of the present disclosure, even when a plurality of TRPs or panels are used, CSI reporting can be appropriately controlled.

### BRIEF DESCRIPTION OF DRAWINGS

FIG. 1 is a diagram to show an example of a multi-TRP scenario.

FIG. 2 is a diagram to show an example of a table showing mapping order of CSI fields of CSI report #n specified in Rel. 16.

FIG. 3 is a diagram to show an example of a table showing mapping order of CSI fields of CSI report #n (CSI part 1) specified in Rel. 16.

FIG. 4 is a diagram to show an example of a table showing mapping order of CSI fields of CSI report #n (CSI part 2 wideband) specified in Rel. 16.

FIG. 5 is a diagram to show an example of a table showing mapping order of CSI fields of CSI report #n (CSI part 2 subband) specified in Rel. 16.

FIGS. 6A and 6B are each a diagram to show an example of a table showing mapping order of CSI reports to a UCI bit sequence specified in Rel. 16.

FIG. 7 is a diagram to show another example of the table showing mapping order of CSI reports to a UCI bit sequence specified in Rel. 16.

FIG. 8 is a diagram to show an example of mapping order of CSI fields according to Option 1-1A of a first aspect.

FIG. 9 is a diagram to show an example of mapping order of CSI fields according to Option 1-1B of the first aspect.

FIG. 10 is a diagram to show an example of mapping order of CSI fields according to Option 1-1C of the first aspect.

FIG. 11 is a diagram to show an example of mapping order of CSI fields according to Option 1-2A of the first aspect.

FIG. 12 is a diagram to show an example of mapping order of CSI fields according to Option 1-2B of the first aspect.

FIG. 13 is a diagram to show an example of mapping order of CSI fields according to Option 1-2C of the first aspect.

FIG. 14 is a diagram to show an example of mapping order of CSI fields according to Option 1-3A of the first aspect.

FIG. 15 is a diagram to show another example of the mapping order of CSI fields according to Option 1-3A of the first aspect.

FIG. 16 is a diagram to show an example of mapping order of CSI fields according to Option 1-3B of the first aspect.

FIG. 17 is a diagram to show another example of the mapping order of CSI fields according to Option 1-3B of the first aspect.

FIG. 18 is a diagram to show an example of mapping order of CSI fields according to Option 1-3C of the first aspect.

FIG. 19 is a diagram to show an example of mapping order of CSI fields according to a variation of the first aspect.

FIG. 20 is a diagram to show another example of the mapping order of CSI fields according to the variation of the first aspect.

FIG. 21 is a diagram to show an example of a schematic structure of a radio communication system according to one embodiment.

FIG. 22 is a diagram to show an example of a structure of a base station according to one embodiment.

FIG. 23 is a diagram to show an example of a structure of a user terminal according to one embodiment.

FIG. 24 is a diagram to show an example of a hardware structure of the base station and the user terminal according to one embodiment.

### DESCRIPTION OF EMBODIMENTS

### (CSI Report (or Reporting))

In Rel-15 NR, a terminal (also referred to as a user terminal, a User Equipment (UE), and the like) generates (also referred to as determines, calculates, estimates, measures, and the like) channel state information (CSI), based on a reference signal (RS) (or a resource for the RS), and transmits (also referred to as reports, feeds back, and the like) the generated CSI to a network (for example, a base station). The CSI may be transmitted to the base station by using an uplink control channel (for example, a Physical Uplink Control Channel (PUCCH)) or an uplink shared channel (for example, Physical Uplink Shared Channel (PUSCH)), for example.

The RS used for the generation of the CSI may be at least one of a channel state information reference signal (CSI-RS), a synchronization signal/broadcast channel (Synchronization Signal/Physical Broadcast Channel (SS/PBCH)) block, a synchronization signal (SS), a demodulation reference signal (DMRS), and the like, for example.

The CSI-RS may include at least one of a non-zero power (NZP) CSI-RS and CSI-Interference Management (CSI-IM). The SS/PBCH block is a block including the SS and the PBCH (and a corresponding DMRS), and may be referred to as an SS block (SSB) or the like. The SS may include at least one of a primary synchronization signal (PSS) and a secondary synchronization signal (SSS).

Note that the CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), L1-RSRP (reference signal received power in Layer 1) (Layer 1 Reference Signal Received Power), L1-RSRQ (Reference Signal Received Quality), an L1-SINR (Signal to Interference plus Noise Ratio), an L1-SNR (Signal to Noise Ratio), and the like.

The UE may receive information (report configuration information) related to a CSI report and control the CSI report based on the report configuration information. The report configuration information may be an information element (IE) “CSI-ReportConfig” of radio resource control (RRC), for example. Note that, in the present disclosure, the RRC IE may be interchangeably interpreted as an RRC parameter, a higher layer parameter, and the like.

The report configuration information (for example, the RRC IE “CSI-ReportConfig”) may include at least one of the following, for example.
Information (report type information, for example, an RRC IE “reportConfigType”) related to a type of the CSI report
Information (report quantity information, for example, an RRC IE “reportQuantity”) related to one or more quantities (one or more CSI parameters) of the CSI to be reported
Information (resource information, for example, an RRC IE “CSI-ResourceConfigId”) related to the resource for the RS used for generation of the quantity (the CSI parameter)
Information (frequency domain information, for example, an RRC IE “reportFreqConfiguration”) related to the frequency domain being a target of the CSI report

For example, the report type information may indicate a periodic CSI (P-CSI) report, an aperiodic CSI (A-CSI) report, or a semi-persistent (semi-permanent) CSI report (SP-CSI) report.

The report quantity information may specify at least one combination of the CSI parameters described above (for example, CRI, RI, PMI, CQI, LI, L1-RSRP, and the like).

The resource information may be an ID of the resource for the RS. The resource for the RS may include, for example, a non-zero power CSI-RS resource or SSB, and a CSI-IM resource (for example, a zero power CSI-RS resource).

The frequency domain information may indicate a frequency granularity of the CSI report. The frequency granularity may include, for example, a wideband and a subband. The wideband is the entire CSI reporting band. The wideband may be the whole of a certain carrier (component carrier (CC), cell, serving cell), or may be the whole of a bandwidth part (BWP) in the certain carrier, for example. The wideband may be interpreted as CSI reporting band, the entire CSI reporting band, and the like.

The subband may be part of the wideband and constituted of one or more resource blocks (RBs) or physical resource blocks (PRBs). The size of the subband may be determined according to the size of the BWP (the number of PRBs).

The frequency domain information may indicate which of a wideband PMI or subband PMI is to be reported (for example, the frequency domain information may include an RRC IE “pmi-FormatIndicator” used to determine which of wideband PMI reporting or subband PMI reporting). The UE may determine the frequency granularity (in other words, wideband PMI reporting or subband PMI reporting) for the CSI report, based on at least one of the report quantity information and frequency domain information.

If wideband PMI reporting is configured (determined), one wideband PMI may be reported for the entire CSI reporting band. On the other hand, if subband PMI reporting is configured, a single wideband indication i₁ may be reported for the entire CSI reporting band, and a subband indication (one subband indication) i₂ for each of one or more subbands (for example, subband indication for each subband) in the entire CSI report may be reported.

The UE performs channel estimation by using the received RS to estimate a channel matrix H. The UE feeds back an index (PMI) determined based on the channel matrix estimated.

The PMI may indicate a precoder matrix (also simply referred to as a precoder) that the UE considers appropriate for the use for downlink (DL) transmission to the UE. Each value of the PMI may correspond to one precoder matrix. Sets of values of the PMI may correspond to different sets of precoder matrices referred to as precoder codebooks (also simply referred to as codebooks).

In the space domain, the CSI report may include one or more types of CSI. For example, the CSI may include at least one of a first type (Type 1 CSI) to be used in selection of a single beam and a second type (Type 2 CSI) to be used in selection of multi-beam. The single beam may be interpreted as a single layer, and the multi-beam may be interpreted as a plurality of beams. Type 1 CSI may be configured not to assume multi-user multiple input multiple output (MIMO) and Type 2 CSI may be configured to assume multi-user MIMO.

The codebook may include a codebook for Type 1 CSI (also referred to as Type 1 codebook or the like) and a codebook for Type 2 CSI (also referred to as Type 2 codebook or the like). Type 1 CSI may include Type 1 single-panel CSI and Type 1 multi-panel CSI, for which respective different codebooks (Type 1 single-panel codebook and Type 1 multi-panel codebook) may be specified.

In the present disclosure, Type 1 and Type I may be interchangeably interpreted. In the present disclosure, Type 2 and Type II may be interchangeably interpreted.

An uplink control information (UCI) type may include at least one of a Hybrid Automatic Repeat reQuest ACKnowledgement (HARQ-ACK), a scheduling request (SR), and CSI. The UCI may be delivered on a PUCCH, or may be delivered on a PUSCH.

In Rel-15 NR, the UCI may include one CSI part for wideband PMI feedback. CSI report #n includes PMI wideband information, if reported.

In Rel-15 NR, the UCI may include two CSI parts for subband PMI feedback. CSI part 1 includes wideband PMI information. CSI part 2 includes single wideband PMI information and some subband PMI information. CSI part 1 and CSI part 2 are coded separately.

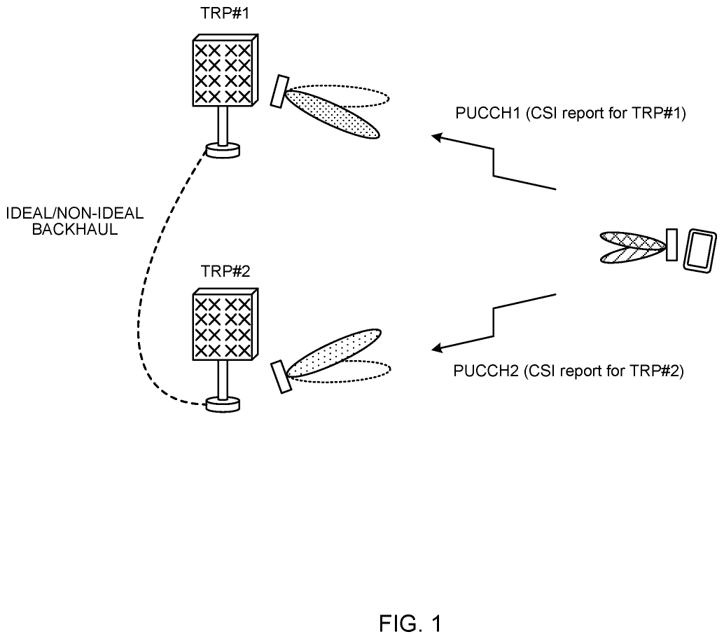

In Rel-15 NR, the UE may be configured with reporting setting of N (N≥1) CSI report configurations and resource setting of M (M≥1) CSI resource configurations, by a higher layer. For example, as shown in FIG. 1, the CSI report configurations (CSI-ReportConfig) includes resource setting for channel measurement (resources ForChannelMeasurement), CSI-IM resource setting for interference (csi-IM-ResourceForInterference), NZP-CSI-RS setting for interference (nzp-CSI-RS-ResourceForInterference), report quantity (reportQuantity), and/or the like. Each of the resource setting for channel measurement, the CSI-IM resource setting for interference, and the NZP-CSI-RS setting for interference is associated with the CSI resource configurations (CSI-ResourceConfig, CSI-ResourceConfigId). The CSI resource configurations include a list of CSI-RS resources sets (csi-RS-ResourceSetList, for example, NZP-CSI-RS resource set or CSI-IM resource set).

When interference measurement is performed in the CSI-IM, each CSI-RS resource for channel measurement is associated with a CSI-IM resource per resource, in order of CSI-RS resources and CSI-IM resources in a corresponding resource set. The number of CSI-RS resources for channel measurement is equal to the number of CSI-IM resources.

In other words, for the interference measurement based on the CSI-IM, there is a one-to-one mapping between cannel measurement resources (CMRs) and interference measurement resources (IMRs).

When the UE is configured with a CSI report configuration having a report quantity (higher layer parameter “reportQuantity”) being set equal to ‘cri-RSRP’, ‘cri-RI-PMI-CQI’, ‘cri-RI-i1’, ‘cri-RI-i1-CQI’, ‘cri-RI-CQI’, or ‘cri-RI-LI-PMI-CQI’, and K_{S} (K_{S}>1) resources are configured in a corresponding resource set for channel measurement, the UE derives a CSI parameter other than the CRI with the reported CRI as a condition. CSI k (k≥0) corresponds to a (k+1)-th entry configured with an associated NZP-CSI-RS resource (nzp-CSI-RSResource) in a corresponding NZP-CSI-RS resource set (nzp-CSI-RS-ResourceSet) for channel measurement and, if configured, to a (k+1)-th entry configured with an associated CSI-IM resource (csi-IM-Resource) in a CSI-IM resource set (csi-IM-ResourceSet).

In other words, CSI k corresponds to a (k+1)-th CMR configured and a (k+1)-th IMR configured.

For both of FRI and FR2, in order to enable more dynamic channel/interference hypotheses for NCJT, evaluation and prescription for CSI reporting for DL transmission for at least one of multi-TRP and multi-panel are under study.

### (Multi-TRP)

For NR, it is under study that one or a plurality of transmission/reception points (TRPs) (multiple TRPs (multi-TRP (M-TRP))) perform DL transmission to a UE by using one or a plurality of panels (multiple panels). It is also under study that the UE performs UL transmission to the one or the plurality of TRPs by using the one or the plurality of panels.

Note that the plurality of TRPs may correspond to the same cell identifier (ID) or may correspond to different cell IDs. The cell ID (s) may be physical cell ID(s) or may be virtual cell ID (s).

FIG. 1 is a diagram to show an example of a multi-TRP scenario. In shown examples, it is assumed that TRPs and UE each can use two different beams, but the examples are not limited to this.

Multiple TRPs (TRPs #0 and #1) may be connected to each other by means of an ideal/non-ideal backhaul, and information, data, and/or the like may be communicated between the multiple TRPs. Each TRP of the multiple TRPs may transmit a different codeword (Code Word (CW)) and a different layer. As one mode of the multi-TRP transmission, non-coherent joint transmission (NCJT) may be used.

In NCJT, for example, TRP #0 performs modulation mapping on a first codeword, performs layer mapping, and transmits a first PDSCH in layers of a first number (for example, two layers) by using first precoding. TRP #1 performs modulation mapping on a second codeword, performs layer mapping, and transmits a second PDSCH in layers of a second number (for example, two layers) by using second precoding.

Note that it may be defined that a plurality of PDSCHs (multiple PDSCHs) transmitted by NCJT partially or completely overlap in at least one of time and frequency domains. In other words, the first PDSCH from the first TRP #0 and the second PDSCH from the second TRP #1 may overlap in at least one of time and frequency resources.

The first PDSCH and second PDSCH may be assumed not to be in a quasi-co-location (QCL) relation (assumed to be not quasi-co-located). Reception of multiple PDSCHs may be interpreted as simultaneous reception of PDSCHs of a QCL type other than a given QCL type (for example, QCL type D).

Based on one or a plurality of DCI, the UE receives a plurality of PDSCHs (which may be referred to as multi-PDSCH (multiple PDSCHs)) from multiple TRPs. In the present example, for the different TRPs, the UE is assumed to separately transmit CSI reporting (CSI report) related to each of the TRPs. Such CSI feedback may be referred to as separate feedback, separate CSI feedback, and the like. Note that CSI feedback to transmit, to one TRP, a CSI report related to both TRPs may be referred to as joint feedback, joint CSI feedback, and the like.

In FIG. 1, the UE is configured to transmit, to TRP #0, a CSI report for TRP #0 by using a given PUCCH (PUCCH 1) and transmit, to TRP #1, a CSI report for TRP #1 by using another PUCCH (PUCCH 2).

The multi-TRP scenario as described above allows more flexible transmission control using a high quality channel.

### (Single-TRP/Multi-TRP CSI Reporting)

It is under study that options as below are supported for CSI reporting related to a multi-TRP/panel NCJT measurement hypothesis configured through single CSI report configuration.

### <Option 1>

The UE may be configured to perform reporting of X CSI/CSIs related to a single-TRP measurement hypothesis and single CSI related to a NCJT (or multi-TRP) measurement hypothesis. X may be configured/defined equal to a given value (for example, X=0, 1, 2).

With X=2, two CSIs may be related to two different single-TRP measurement hypotheses having channel measurement resources (CMRs) of different CMR groups. A case of X=1, 2 may be options for the UE that supports Option 1.

### <Option 2>

The UE may be configured to perform reporting of single CSI related to the best CSI in NCJT (or multi-TRP) and single-TRP measurement hypotheses.

The single CSI report configuration for multiple TRPs may correspond to both of Option 1 (for example, X=0/1/2) and Option 2.

### (Mapping Order in CSI Field of CSI Report)

In an existing system (for example, Rel. 16 or earlier versions), mapping order of CSI fields of one CSI report is specified. For example, one or more parameters (or contents) are mapped to CSI fields of a given CSI report (for example, CSI report #n) based on a given order.

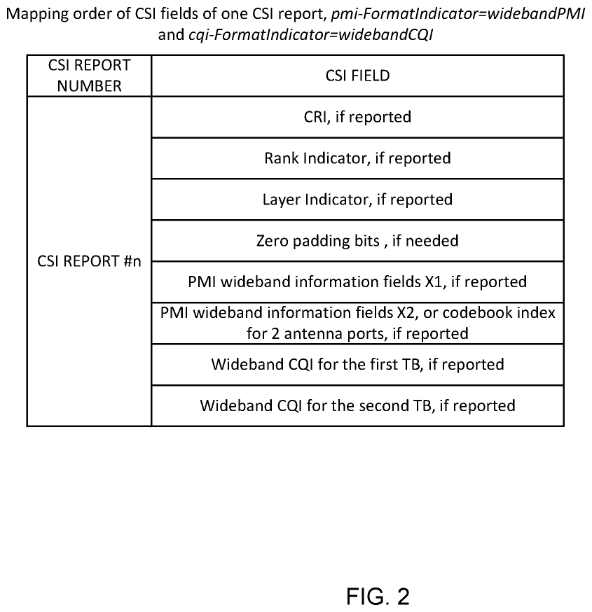

FIG. 2 shows an example of a table showing mapping order of CSI fields of CSI report #n specified in Rel. 16. FIG. 2 corresponds to mapping order of CSI fields of CSI report #n when a PMI format indicator indicates wideband PMI (for example, pmi-FormatIndicatro=widebandPMI) and a COI format indicator indicates wideband CQI (for example, cqi-Format Indicatro=widebandCQI).

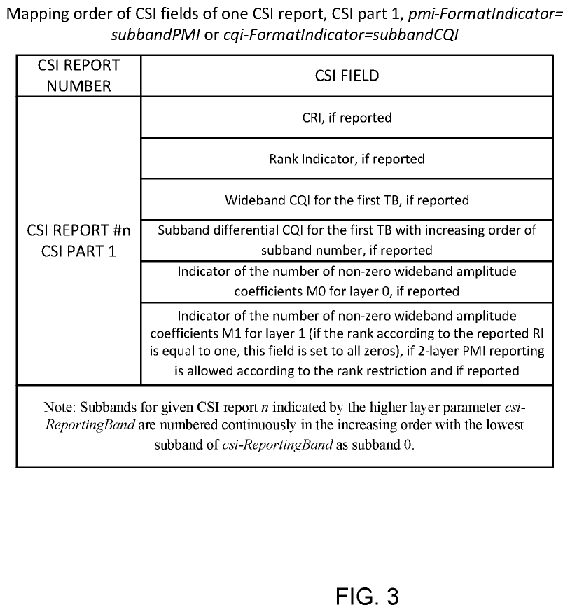

FIG. 3 shows an example of a table showing mapping order of CSI fields of CSI report #n (CSI part 1) specified in Rel. 16. FIG. 3 corresponds to mapping order of CSI fields of CSI report #n (CSI part 1) when the PMI format indicator indicates subband PMI (for example, pmi-FormatIndicatro=subbandPMI) and the CQI format indicator indicates subband CQI (for example, cqi-Format Indicatro=subbandCQI).

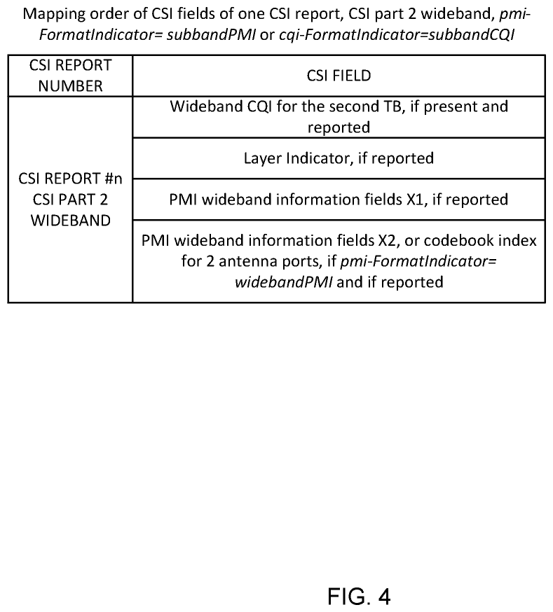

FIG. 4 shows an example of a table showing mapping order of CSI fields of CSI report #n (CSI part 2 wideband) specified in Rel. 16. FIG. 4 corresponds to mapping order of CSI fields of CSI report #n (CSI part 2 wideband) when the PMI format indicator indicates subband PMI (for example, pmi-Format Indicatro=subbandPMI) or the COI format indicator indicates subband CQI (for example, cqi-Format Indicatro=subbandCQI).

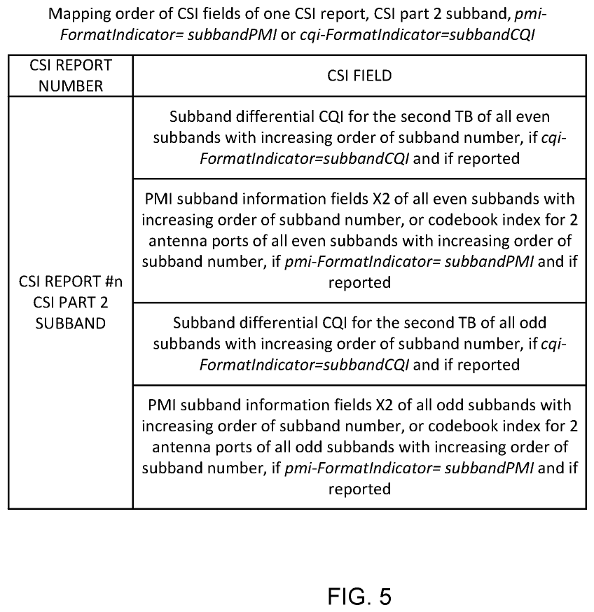

FIG. 5 shows an example of a table showing mapping order of CSI fields of CSI report #n (CSI part 2 subband) specified in Rel. 16. FIG. 5 corresponds to mapping order of CSI fields of CSI report #n (CSI part 2 subband) when the PMI format indicator indicates subband PMI (for example, pmi-Format Indicatro=subbandPMI) or the COI format indicator indicates subband CQI (for example, cqi-Format Indicatro=subbandCQI).

FIGS. 2 to 5 each shows mapping order of CSI fields of a CSI report when the CSI report is to be transmitted using an uplink control channel (for example, PUCCH). In Rel. 16, mapping order of CSI fields of a CSI report when the CSI report is to be transmitted using an uplink shared channel (for example, PUSCH) is also defined similarly in a table.

### (Mapping Order of CSI Reports to UCI Bit Sequence)

In an existing system (for example, Rel. 16 or earlier versions), mapping order of CSI reports to a UCI bit sequence (mapping order of CSI reports to UCI bit sequence) is specified. For example, one or more CSI reports are mapped to a given UCI bit sequence based on a given order.

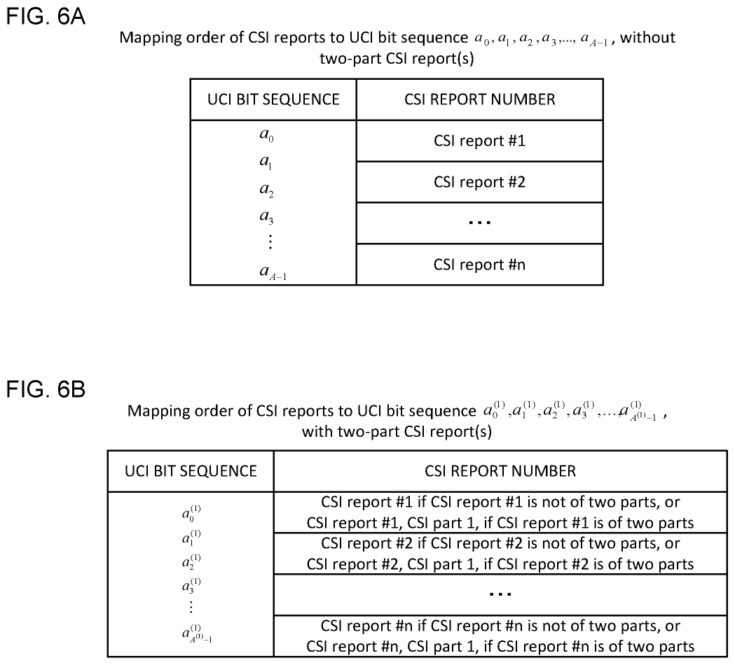

FIG. 6A shows an example of a table showing mapping order of CSI reports to a UCI bit sequence specified in Rel. 16. FIG. 6A corresponds to mapping order of CSI reports to a UCI bit sequence when two-part CSI report is not applied (for example, without two-part CSI report (s)).

FIG. 6B shows another example of the table showing mapping order of CSI reports to a UCI bit sequence specified in Rel. 16. FIG. 6B corresponds to mapping order of CSI reports to a first UCI bit sequence when two-part CSI report is applied (for example, with two-part CSI report (s)).

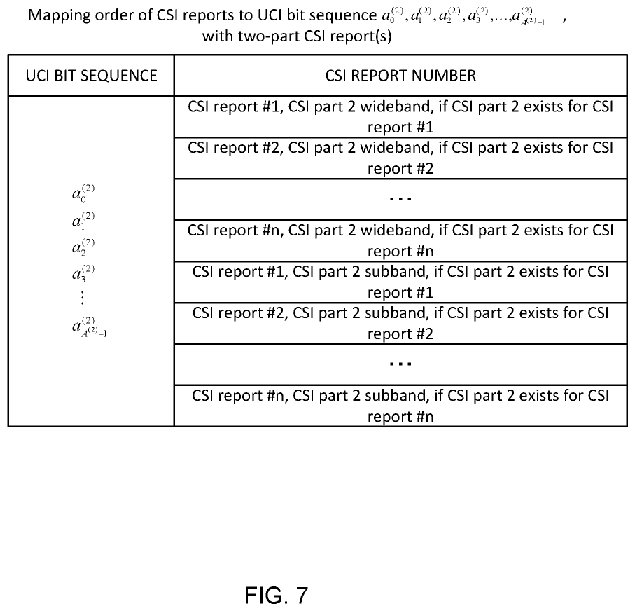

FIG. 7 shows another example of the table showing mapping order of CSI reports to a UCI bit sequence specified in Rel. 16. FIG. 7 corresponds to mapping order of CSI reports to a second UCI bit sequence when two-part CSI report is applied (for example, with two-part CSI report (s)).

FIGS. 6A, 6B, and 7 each shows mapping order of CSI reports to a UCI bit sequence when the CSI reports are to be transmitted using an uplink control channel (for example, PUCCH). In Rel. 16, mapping order of CSI reports to a UCI bit sequence when the CSI reports are to be transmitted using an uplink shared channel (for example, PUSCH) is also defined similarly in a table.

However, in the NR specifications thus far, studies have not sufficiently been made on control of CSI reporting when the multiple panels/multiple TRPs are used.

For example, CSI report #n is assumed to correspond to a single-TRP measurement hypothesis or a multi-TRP NCJT measurement hypothesis (for example, MTRP NCJT measurement hypothesis). However, regarding CSI report #n corresponding to the multi-TRP measurement hypothesis, such CSI report #n is assumed to include parameters/contents different from that of a CSI report in an existing system. In this case, a problem is how to control mapping order related to the CSI report.

In view of this, the inventors of the present invention studied on CSI reporting with a multi-TRP measurement hypothesis, and came up with the idea of a method of performing CSI reporting appropriately. According to one aspect of the present disclosure, the UE can appropriately perform CSI reporting including a multi-TRP measurement hypothesis.

Note that, in the present disclosure, “A/B” may mean “at least one of A and B.” “A/B/C” may mean “at least one of A, B, and C.”

In the present disclosure, activate, deactivate, indicate, select, configure, update, determine, and the like may be interchangeably interpreted.

In the present disclosure, RRC, an RRC parameter, an RRC message, a higher layer parameter, an information element (IE), and a configuration may be interchangeably interpreted. In the present disclosure, a MAC CE, an update command, and an activation/deactivation command may be interchangeably interpreted. In the present disclosure, “support,” “control,” “may control,” “operate,” and “may operate” may be interchangeably interpreted.

In the present disclosure, a panel, a beam, a panel group, a beam group, an Uplink (UL) transmission entity, a TRP, spatial relation information (SRI), a spatial relation, a control resource set (CORESET), a Physical Downlink Shared Channel (PDSCH), a codeword, a base station, a given antenna port (for example, a demodulation reference signal (DMRS) port), a given antenna port group (for example, a DMRS port group), a given group (for example, a code division multiplexing (CDM) group, a given reference signal group, or a CORESET group), a given resource (for example, a given reference signal resource), a given resource set (for example, a given reference signal resource set), a CORESET pool, a PUCCH group (PUCCH resource group), a spatial relation group, a downlink TCI state (DL TCI state), an uplink TCI state (UL TCI state), a unified TCI state, QCL, and the like may be interchangeably interpreted.

A TCI state Identifier (ID) and a TCI state may be interchangeably interpreted. A TCI state and a TCI may be interchangeably interpreted.

In the present disclosure, an index, an ID, an indicator, and a resource ID may be interchangeably interpreted. In the present disclosure, a sequence, a list, a set, a group, a cluster, a subset, and the like may be interchangeably interpreted.

In the present disclosure, a TRP index, a CORESET pool index (CORESETPoolIndex), a pool index, a group index, a CSI report setting group index, a CSI reporting group index, a CSI report configuration index, a CSI reporting setting group index, and a resource setting group index may be interchangeably interpreted.

The control on mapping of CSI reports (or CSI fields) in the present disclosure may be applied to both of a case where UCI (for example, UCI including at least CSI) is transmitted on a PUCCH (e.g., UCI on PUCCH) and a case where UCI is transmitted on a PUSCH (UCI on PUSCH).

The control on mapping of CSI reports (or CSI fields) in the present disclosure may be used when multiple TRPs are configured for a UE and may be used when the separate feedback is used for the CSI feedback (for the multiple TRPs). The control on mapping of CSI reports in the present disclosure may be used, without limited to the above, when the joint feedback is used.

### (First Aspect)

In a first aspect, a case will be described in which given parameters corresponding to a plurality of TBs are reported in certain CSI report #n for a multi-TRP (or MTRP NCJT) measurement hypothesis. In the following description, a case will be described in which a given parameter corresponding to a first TB and a given parameter corresponding to a second TB are reported as the given parameters corresponding to the plurality of TBs, but the number of TBs are not limited to this.

The first TB may be interpreted as a first TRP or a first CORESET pool index. The second TB may be interpreted as a second TRP or a second CORESET pool index.

The given parameter may be interpreted as at least one of a given content, a given indicator, a given information field, and a given codebook index. In the following description, examples of the given parameter include a layer indicator (for example, Layer Indicator), a PMI wideband information field, a PMI subband information field, or a codebook index, but the given parameter is not limited to these.

In CSI report #n, when parameters/contents corresponding to the plurality of TBs/TRPs (for example, the first TB/TRP and second TB/TRP) are included, at least one of Option 1-1 to Option 1-3 as below may be applied as mapping order in CSI fields of CSI report #n.

### <Option 1-1>

Regarding contents included in CSI report #n, each of contents corresponding to the first TB may be allocated/mapped before a respective one of contents corresponding to the second TB. In other words, in units of contents, the mapping order for the first TB may be configured to be earlier than the mapping order for the second TB.

### <<Option 1-1A>>

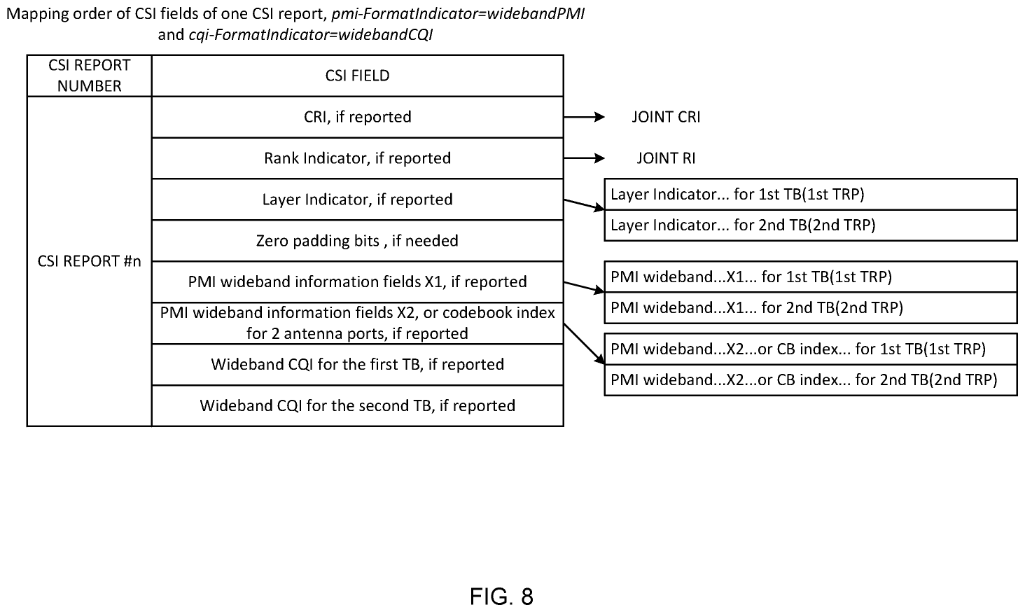

FIG. 8 shows an example of mapping order of CSI fields of CSI report #n when the PMI format indicator indicates wideband PMI (for example, pmi-Format Indicatro=widebandPMI) and the CQI format indicator indicates wideband CQI (for example, cqi-FormatIndicatro=widebandCQI).

For example, in a first content/parameter (for example, layer indicator (LI)) mapped to a CSI field, an LI corresponding to the first TB may be mapped before an LI corresponding to the second TB.

Similarly, in a second content/parameter (for example, PMI wideband information fields X1), a PMI wideband information field X1 corresponding to the first TB may be mapped before a PMI wideband information field X1 corresponding to the second TB. Also, in a third content/parameter (for example, PMI wideband information field X2 or CB index), a PMI wideband information field X2 or CB index corresponding to the first TB may be mapped before a PMI wideband information field X2 or CB index corresponding to the second TB.

The control may be performed such that the first TB is mapped before the second TB for all of the plurality of contents/parameters (for example, first to third contents/parameters) or the control may be performed such that the first TB is mapped before the second TB for some of the contents/parameters.

In FIG. 8, a CRI field may include a joint CRI field. The joint CRI field may have a structure to indicate or include two CSI-RS resources (or two CMRs) for two TRPs.

An RI field may include a joint RI field. The joint RI field may have a structure to indicate or include two RI values for two TRPs. For example, with the maximum number of communication layers being four or less, {1, 1}, {1, 2}, {2, 1}, and {2, 2} may be supported as a combination of RIs in the joint RI field for the first TRP and second TRP.

Note that, similarly to the LI/PMI, the CRI field/RI field may also have a structure in which a CRI/RI corresponding to the first TB is mapped before a CRI/RI corresponding to the second TB, instead of the joint field.

In FIG. 8, a wideband COI field corresponding to the first TB may include a wideband CQI corresponding to the first TB (or first TRP), and a wideband CQI field corresponding to the second TB may include a wideband COI corresponding to the second TB (or second TRP).

### <<Option 1-1B>>

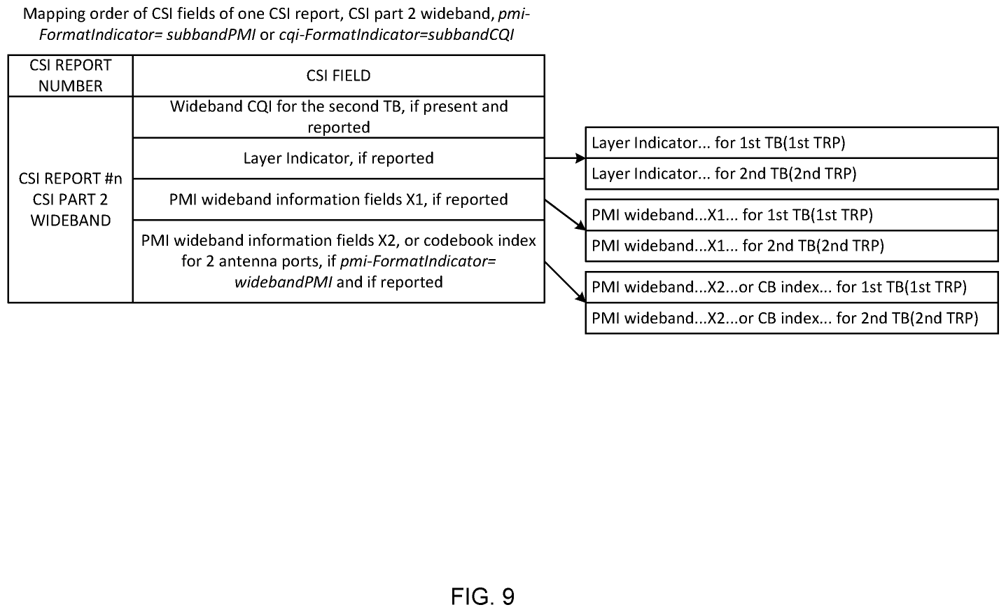

FIG. 9 shows an example of mapping order of CSI fields of CSI report #n (CSI part 2 wideband) when the PMI format indicator indicates subband PMI (for example, pmi-Format Indicatro=subbandPMI) or the COI format indicator indicates subband CQI (for example, cqi-Format Indicatro=subbandCQI).

For example, in a first content/parameter (for example, layer indicator (LI)) mapped to a CSI field, an LI corresponding to the first TB may be mapped before an LI corresponding to the second TB.

Similarly, in a second content/parameter (for example, PMI wideband information fields X1), a second content/parameter corresponding to the first TB may be mapped before a second content/parameter corresponding to the second TB. Also, in a third content/parameter (for example, PMI wideband information field X2 or CB index), a third content/parameter corresponding to the first TB may be mapped before a third content/parameter corresponding to the second TB.

The control may be performed such that the first TB is mapped before the second TB for all of the plurality of contents/parameters (for example, first to third contents/parameters). Alternatively, the control may be performed such that the first TB is mapped before the second TB for some of the contents/parameters.

In FIG. 9, a wideband CQI field corresponding to the second TB may include a wideband COI corresponding to the second TB (or second TRP).

### <<Option 1-1C>>

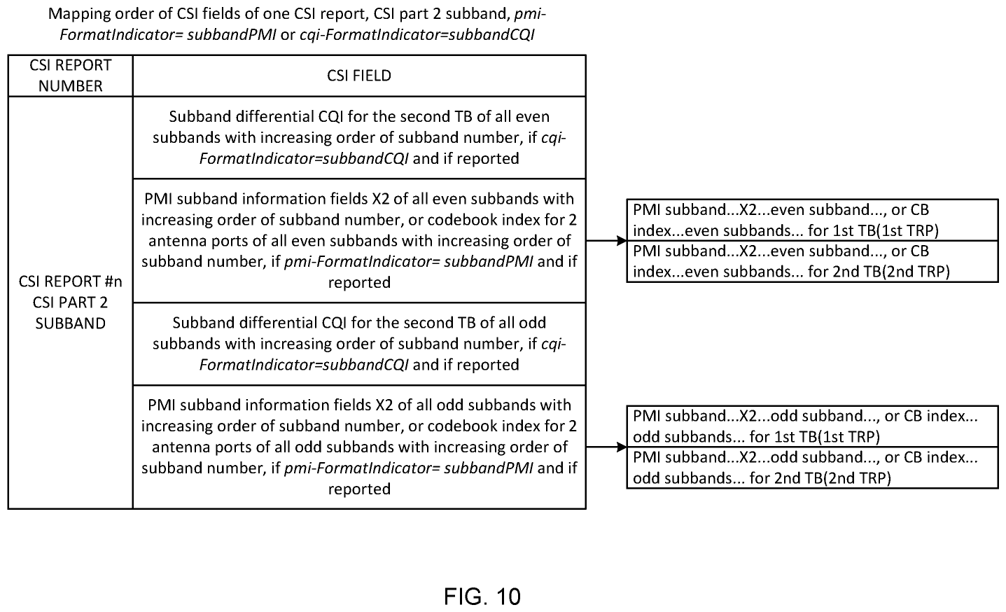

FIG. 10 shows an example of mapping order of CSI fields of CSI report #n (CSI part 2 subband) when the PMI format indicator indicates subband PMI (for example, pmi-FormatIndicatro=subbandPMI) or the COI format indicator indicates subband CQI (for example, cqi-Format Indicatro=subbandCQI).

For example, in a first content/parameter (for example, a PMI subband information field X2 of given even-numbered subbands or a CB index of given even-numbered subbands) mapped to a CSI field, a first content corresponding to the first TB may be mapped before a first content corresponding to the second TB.

Similarly, in a second content/parameter (for example, a PMI subband information field X2 of given odd-numbered subbands or a CB index of given odd-numbered subbands), a second content corresponding to the first TB may be mapped before a second content corresponding to the second TB.

The control may be performed such that the first TB is mapped before the second TB for all of the plurality of contents/parameters (for example, first to second contents/parameters). Alternatively, the control may be performed such that the first TB is mapped before the second TB for some of the contents/parameters.

In FIG. 10, a subband differential CQI field corresponding to the second TB may include a COI corresponding to the second TB (or second TRP).

As described above, as shown in Option 1-1, in a field including a parameter corresponding to a plurality of TRPs, mapping order is controlled based on a corresponding TB index/TRP index, so that CSI reporting can be appropriately performed.

### <Option 1-2>

Regarding all sets of two parameters/contents corresponding to two TRPs included in CSI report #n, a set of contents corresponding to the first TB may be allocated/mapped before a set of contents corresponding to the second TB. In other words, with reference to a corresponding TB index/TRP index (regardless of a substance of a parameter/content), the control is performed such that a content corresponding to the first TB is allocated before a content corresponding to the second TB.

### <<Option 1-2A>>

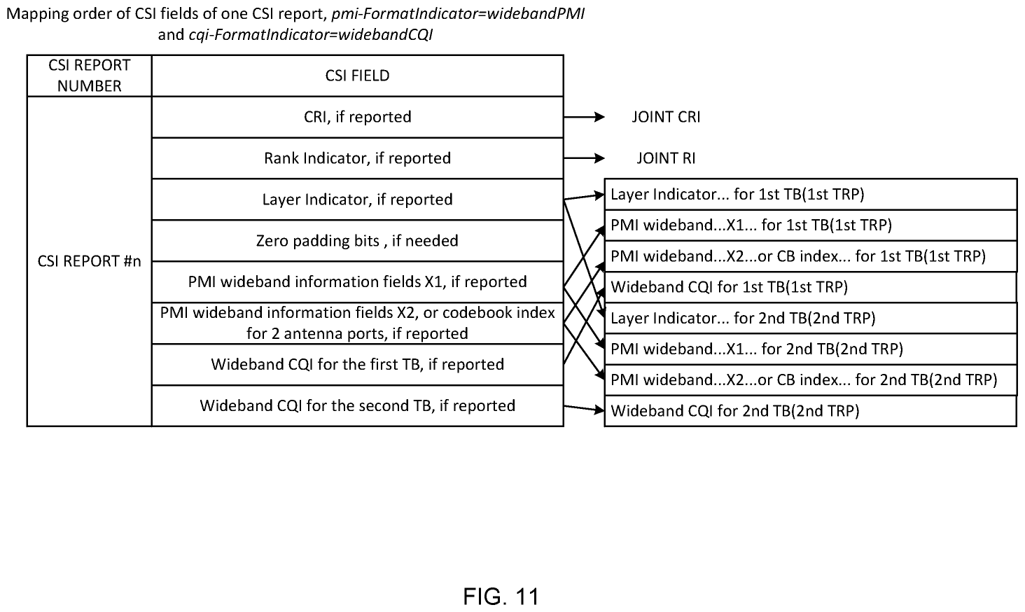

FIG. 11 shows an example of mapping order of CSI fields of CSI report #n when the PMI format indicator indicates wideband PMI (for example, pmi-Format Indicatro=widebandPMI) and the CQI format indicator indicates wideband CQI (for example, cqi-FormatIndicatro=widebandCQI).

For example, in a CSI field, an “LI”/“PMI wideband information field X1”/“PMI wideband information field X2 or CB index”/“wideband COI” corresponding to the first TB may be mapped before “LI”/“PMI wideband information field X1”/“PMI wideband information field X2 or CB index”/“wideband CQI” corresponding to the second TB.

In this case, a joint CRI/RI field may be mapped before an LI/PMI wideband information field X1/PMI wideband information field X2 or CB index/wideband CQI corresponding to the first TB.

### <<Option 1-2B>>

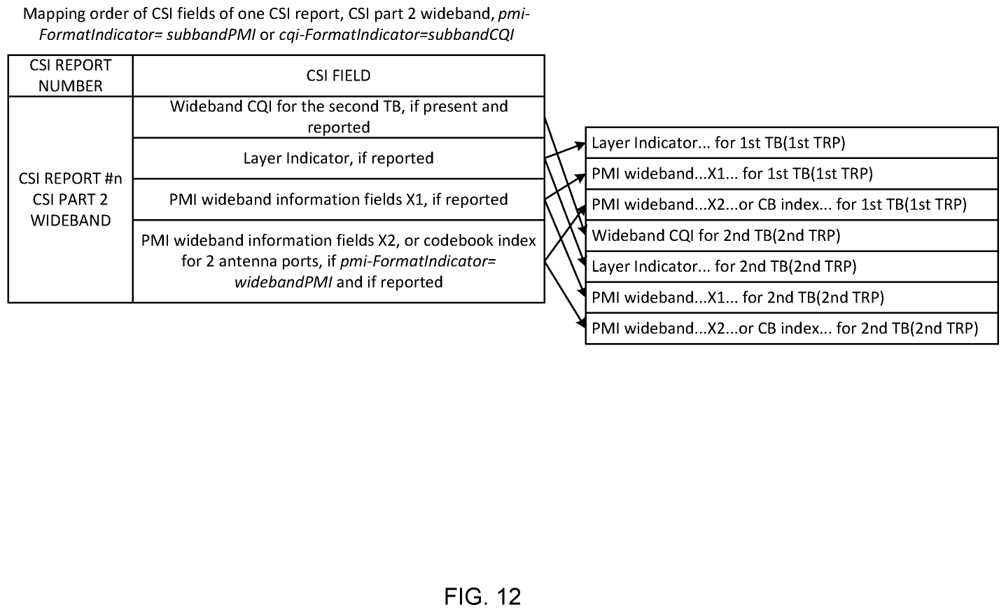

FIG. 12 shows an example of mapping order of CSI fields of CSI report #n (CSI part 2 wideband) when the PMI format indicator indicates subband PMI (for example, pmi-Format Indicatro=subbandPMI) or the CQI format indicator indicates subband CQI (for example, cqi-Format Indicatro=subbandCQI).

For example, in a CSI field, an “LI”/“PMI wideband information field X1”/“PMI wideband information field X2 or CB index” corresponding to the first TB may be mapped before an “LI”/“PMI wideband information field X1”/“PMI wideband information field X2 or CB index” corresponding to the second TB.

A wideband CQI field corresponding to the second TB may be mapped before an “LI” corresponding to the second TB.

### <<Option 1-2C>>

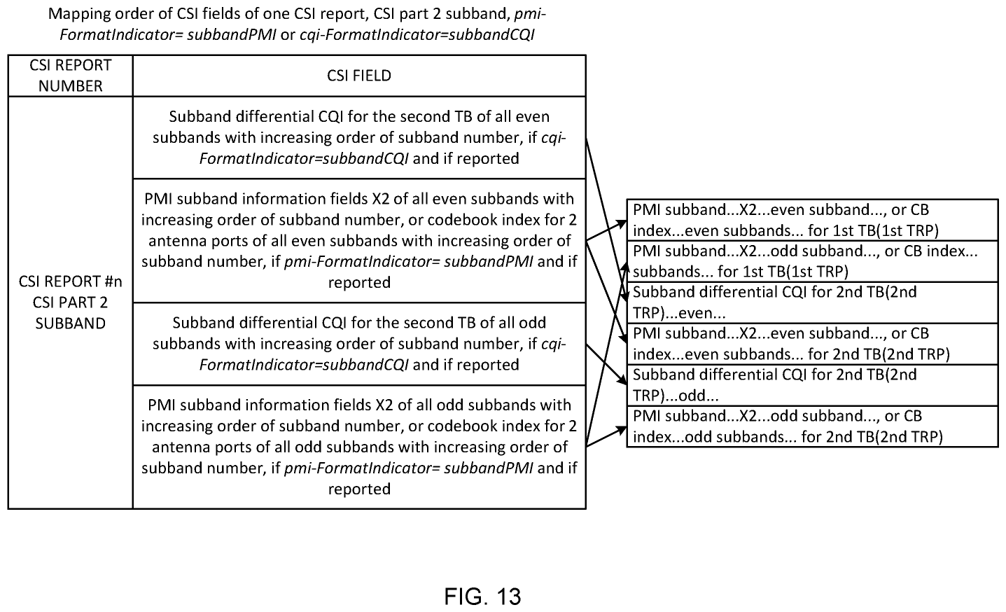

FIG. 13 shows an example of mapping order of CSI fields of CSI report #n (CSI part 2 subband) when the PMI format indicator indicates subband PMI (for example, pmi-Format Indicatro=subbandPMI) or the COI format indicator indicates subband CQI (for example, cqi-Format Indicatro=subbandCQI).

For example, in a CSI field, a “PMI subband information field X2 of given even-numbered subbands or CB index of given even-numbered subbands”/“PMI subband information field X2 of given odd-numbered subbands or CB index of given odd-numbered subbands” corresponding to the first TB may be mapped before a “PMI subband information field X2 of given even-numbered subbands or CB index of given even-numbered subbands”/“PMI subband information field X2 of given odd-numbered subbands or CB index of given odd-numbered subbands” corresponding to the second TB.

The control may be performed such that a subband differential CQI (even-numbered subband) for the second TB/subband differential CQI (odd-numbered subband) for the second TB may be mapped after a parameter corresponding to the first TB.

### <Option 1-3>

Option 1-1 and Option 1-2 may be combined to be applied. For example, Option 1-1 may be applied for certain one or more fields included in CSI report #n, and Option 1-2 may be applied for the other plurality of fields.

### <<Option 1-3A>>

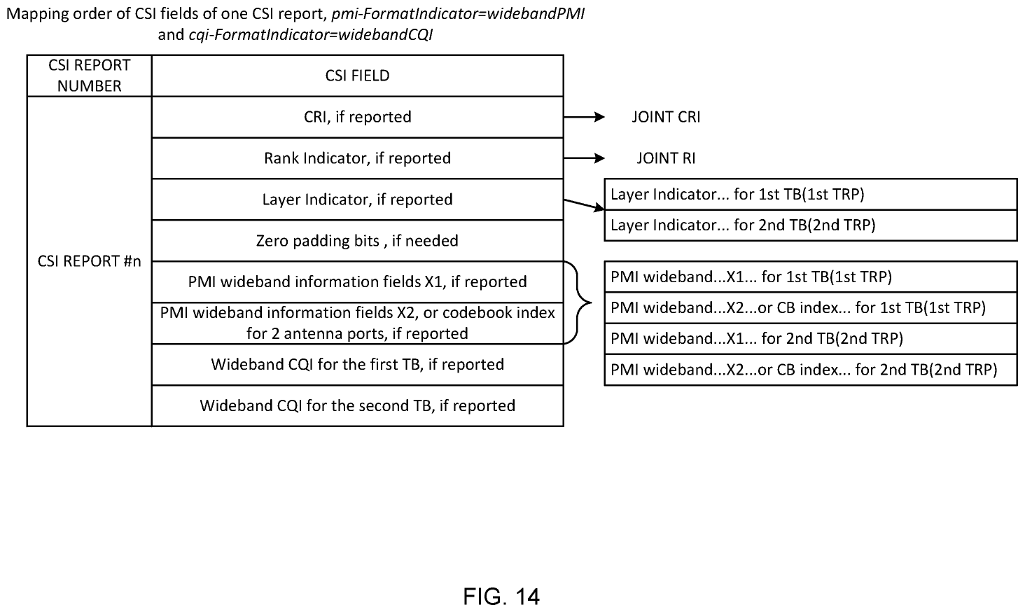

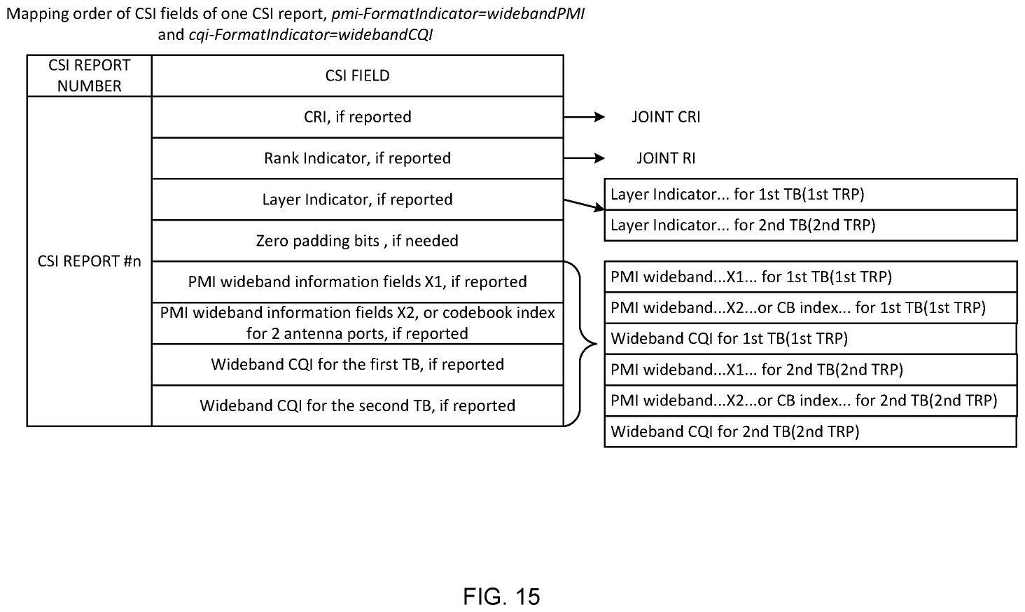

FIGS. 14 and 15 each show an example of mapping order of CSI fields of CSI report #n when the PMI format indicator indicates wideband PMI (for example, pmi-FormatIndicatro=widebandPMI) and the COI format indicator indicates wideband COI (for example, cqi-Format Indicatro=widebandCQI).

For example, in a CSI field, Option 1-1 may be applied for a first content/parameter (for example, layer indicator (LI)), and Option 1-2 may be applied for a combination of a second content/parameter (for example, PMI wideband information field X1) and a third content/parameter (for example, PMI wideband information field X2 or CB index) (see FIG. 14).

Alternatively, Option 1-2 may be applied for the second content/parameter (for example, PMI wideband information field X1), the third content/parameter (for example, PMI wideband information field X2 or CB index), and a fourth content/parameter (for example, wideband CQI field) (see FIG. 15).

As described above, fields for which Option 1-1 and Option 1-2 are to be applied are determined separately, so that mapping order can be flexibly controlled.

### <<Option 1-3B>>

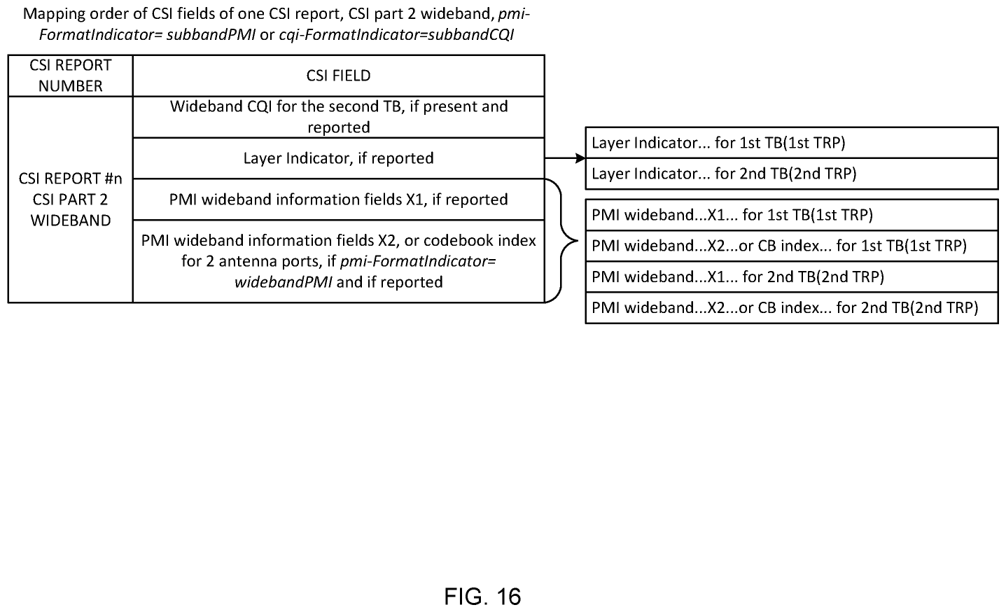

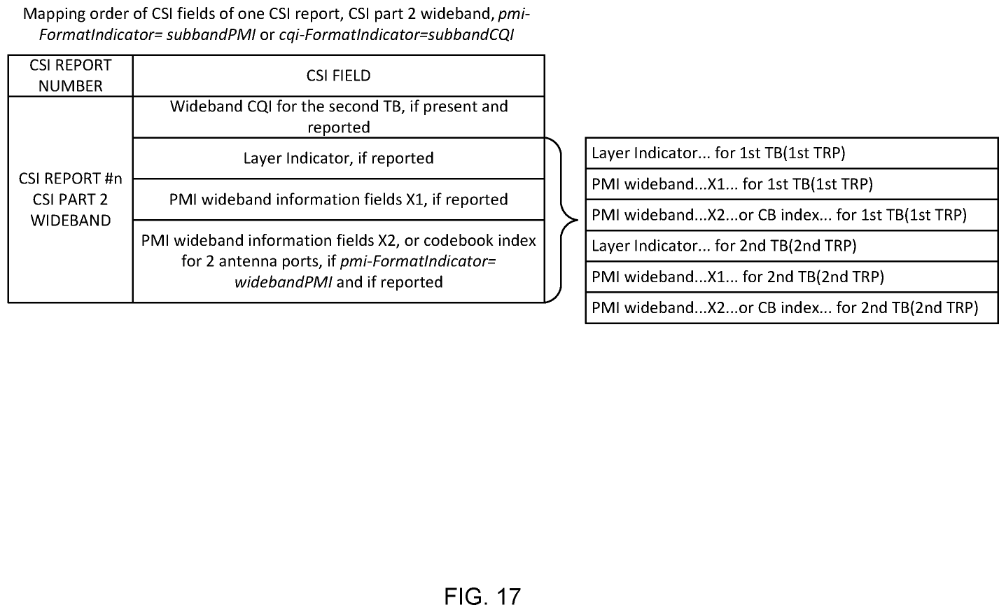

FIGS. 16 and 17 each shows an example of mapping order of CSI fields of CSI report #n (CSI part 2 wideband) when the PMI format indicator indicates subband PMI (for example, pmi-Format Indicatro=subbandPMI) or the COI format indicator indicates subband CQI (for example, cqi-Format Indicatro=subbandCQI).

For example, in a CSI field, Option 1-1 may be applied for a first content/parameter (for example, layer indicator (LI)), and Option 1-2 may be applied for a combination of a second content/parameter (for example, PMI wideband information field X1) and a third content/parameter (for example, PMI wideband information field X2 or CB index) (see FIG. 16).

Alternatively, Option 1-2 may be applied for a combination of the first content/parameter (for example, layer indicator (LI)), the second content/parameter (for example, PMI wideband information field X1), and the third content/parameter (for example, PMI wideband information field X2 or CB index) (see FIG. 17). In this case, a fourth content/parameter (for example, wideband COI field) corresponding to the second TB may be mapped before the first content/parameter corresponding to the first TB.

### <<Option 1-3C>>

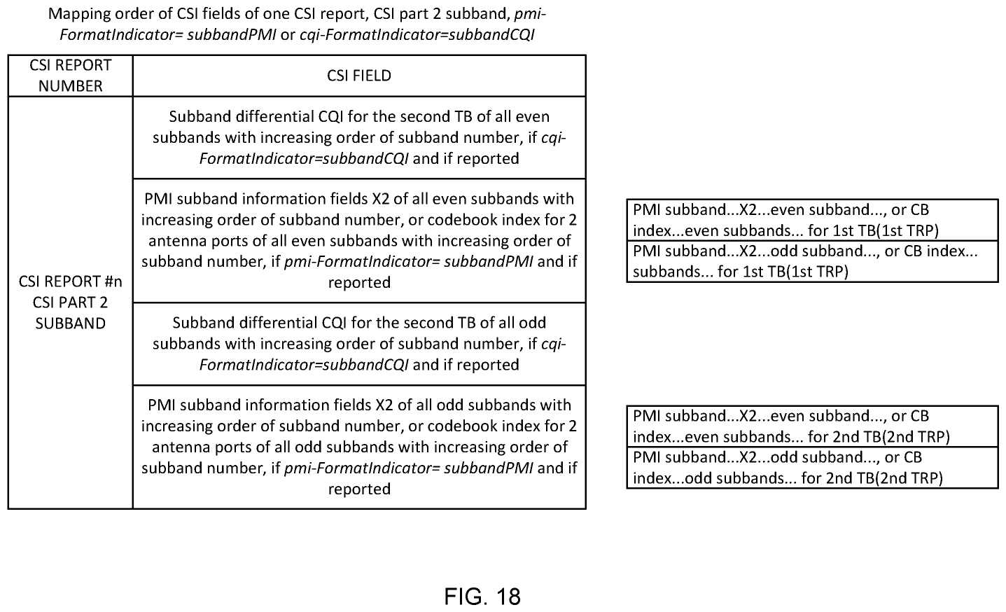

FIG. 18 shows an example of mapping order of CSI fields of CSI report #n (CSI part 2 subband) when the PMI format indicator indicates subband PMI (for example, pmi-Format Indicatro=subbandPMI) or the COI format indicator indicates subband CQI (for example, cqi-Format Indicatro=subbandCQI).

For example, in a CSI field, Option 1-2 may be applied for a combination of a first content/parameter (for example, PMI subband information field X2 of given even-numbered subbands or CB index of given even-numbered subbands) and a second content/parameter (for example, PMI subband information field X2 of given odd-numbered subbands or CB index of given odd-numbered subbands) (see FIG. 18).

A subband differential COI (odd-numbered subband/even-numbered subband) field corresponding to the second TB may be mapped before a parameter corresponding to the first TB or may be mapped after the parameter corresponding to the first TB.

### Variations

In the description above, a case is described in which mapping order is determined based on a TB index/TRP index, but the present disclosure is not limited to this.

For example, regarding different contents/parameters, the control may be performed such that contents/parameters corresponding to the first TB and second TB are consecutively mapped.

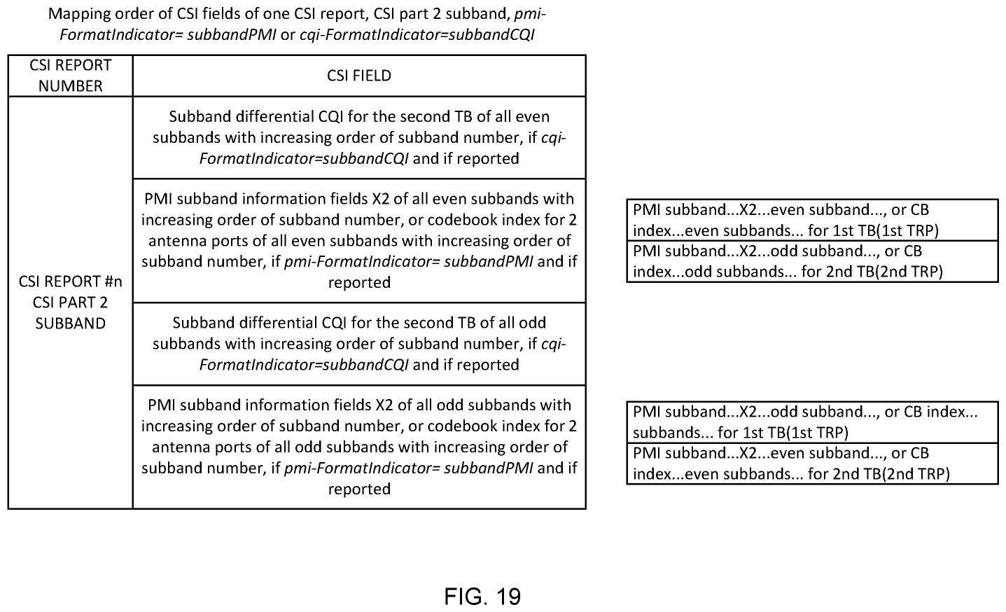

FIG. 19 shows an example of mapping order of CSI fields of CSI report #n (CSI part 2 subband) when the PMI format indicator indicates subband PMI (for example, pmi-Format Indicatro=subbandPMI) or the COI format indicator indicates subband CQI (for example, cqi-Format Indicatro=subbandCQI).

For example, in a CSI field, a first content/parameter (for example, PMI subband information field X2 of given even-numbered subbands or CB index of given even-numbered subbands) corresponding to the first TB and a second content/parameter (for example, PMI subband information field X2 of given odd-numbered subbands or CB index of given odd-numbered subbands) corresponding to the second TB are mapped consecutively. Similarly, a second content/parameter corresponding to the first TB and a first content/parameter corresponding to the second TB may be mapped consecutively.

In a table defined in an existing system, a parameter corresponding to a given TB (for example, first TB/second TB) may include substance of report for the given TB (TRP).

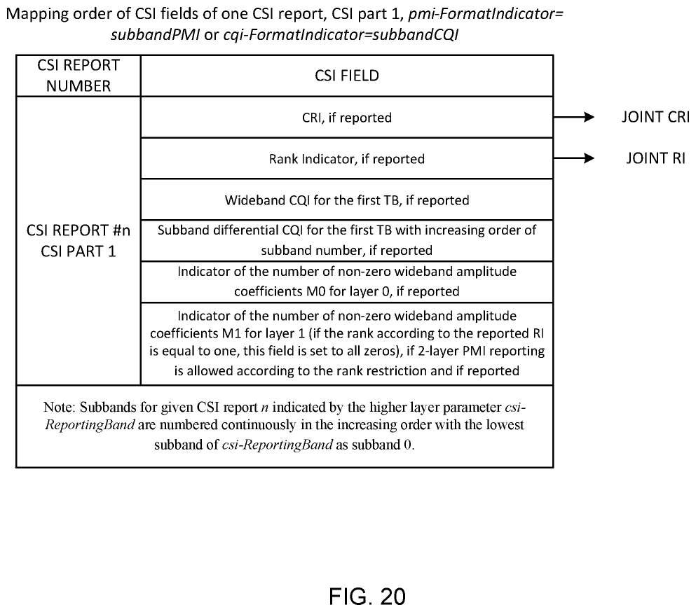

FIG. 20 corresponds to mapping order of CSI fields of CSI report #n (CSI part 1) when the PMI format indicator indicates subband PMI (for example, pmi-Format Indicatro=subbandPMI) and the COI format indicator indicates subband COI (for example, cqi-FormatIndicatro=subbandCQI). Here, a wideband COI field may include a CQI corresponding to the first TB (or forst TRP), and a subband differential COI field may include a COI corresponding to the first TB (or first TRP). A CRI field/RI field may include a joint CRI field/joint RI field.

A structure may be used in which a given parameter (for example, LI/PMI) for the second TB (or second TRP) of CSI report #n is present only when the CRI report (for example, CRI reporting) indicates that CSI report #n is for multi-TRP (or NCJT) measurement hypothesis.

In this case, the UE/base station may understand a certain parameter (for example, RI) as indication of joint of two RI fields.

In this case, a COI for the second TB (second TRP) may be configured to be present in any rank (for example, rank<4).

A table when UCI is transmitted using a PUCCH is described for Option 1-1 to Option 1-3, but the present disclosure is not limited to this. Option 1-1 to Option 1-3 may be also applied for a table when UCI is transmitted using a PUSCH (UCI on PUSCH).

As described above, when reporting of CSI (or measurement hypothesis) is performed for a plurality of TRPs, a given content/parameter of a CSI field includes contents corresponding to the first TB/TRP and second TB/TRP. In this case, mapping order in CSI fields is determined based on a given condition, so that CSI reporting can be appropriately performed even when measurement hypotheses for the plurality of TRPs are to be reported.

Note that, when CSI reporting including a single-TRP measurement hypothesis is performed, a mechanism in an existing system may be reused, regarding contents to be included in parameters in CSI fields/mapping order.

### (Second Aspect)

In a second aspect, regarding a certain parameter/content in CSI reporting, a case will be described in which reporting is performed in common/jointly between a plurality of TBs/TRPs (for example, first TB/TRP and second TB/TRP). Note that, in the following description, RI or PMI will be described as an example of a parameter/content, but the parameter/content applicable is not limited to this. The second aspect may be applied in combination with the first aspect (for example, may be applied for the table described in the first aspect).

### <RI Sharing>

For CSI for NCJT (or multi-TRP), RI sharing may be configured/activated/indicated by RRC. In this case, the UE may perform control to report a common RI for a plurality of (for example, two) TRPs.

When joint RI reporting is configured, a joint RI to be reported may be limited (Option 2-1). For example, the joint RI may be configured to indicate only a combination of two same values. As an example, as the joint RI, either of {1, 1} or {2, 2} may be reported.

Alternatively, as the joint RI, a single RI value may be reported (Option 2-2). In this case, the single RI may be configured to be used for/correspond to CSI of a plurality of (for example, two) TRPs. This allows an increase in overhead of the RI field to be suppressed.

### <PMI Sharing>

For CSI for NCJT (or multi-TRP), PMI sharing may be configured/activated/indicated by RRC. In this case, configuration with reporting of a PMI/LI for the second TB (second TRP) being omitted may be employed.

When the PMI sharing is applied, the UE may perform control not to perform reporting of the PMI/LI for the second TB (or second TRP). In this case, a table defined in an existing system (for example, Rel. 16) may be applied to control CSI reporting. In a table defined in an existing system, a CRI/RI may be interpreted as a joint CRI/joint RI.

Configuration may be employed in which, when the PMI sharing is not configured for CSI for NCJT (or multi-TRP), reporting of a PMI/LI for the second TB (second TRP) is necessary.

When the PMI sharing is not applied, the UE may perform control to perform reporting of the PMI/LI for the second TB (second TRP). In this case, the table described in the first aspect may be used to control CSI reporting.

As described above, substance to be included in a PMI are changed depending on whether PMI sharing is configured/used/activated, so that substance of CSI reporting can be flexibly controlled.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

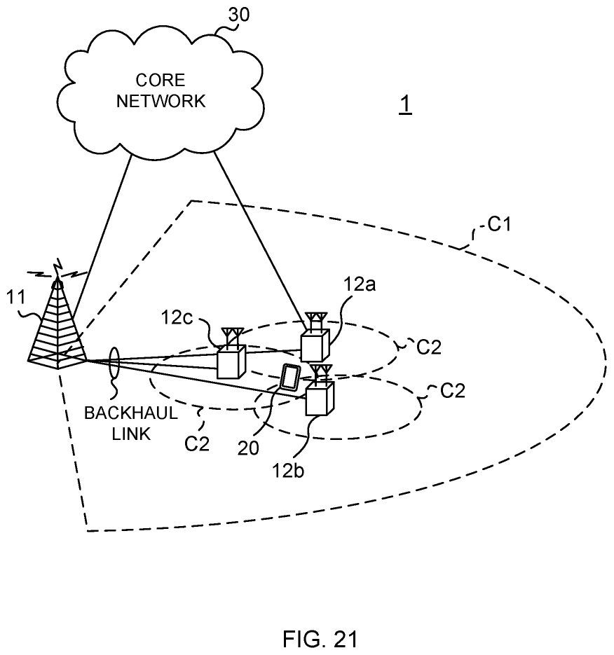

FIG. 21 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FRI may be a frequency band of 6 GHz or less (sub-6 GHZ), and FR2 may be a frequency band which is higher than 24 GHZ (above-24 GHz). Note that frequency bands, definitions and so on of FRI and FR2 are by no means limited to these, and for example, FRI may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are transmitted on the PDSCH. User data, higher layer control information and so on may be transmitted on the PUSCH. The Master Information Blocks (MIBs) may be transmitted on the PBCH.

Lower layer control information may be transmitted on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be transmitted by means of the PUCCH. By means of the PRACH, random access preambles for establishing connections with cells may be transmitted.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be transmitted. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be transmitted as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be transmitted as an uplink reference signal (UL-RS). Note that DMRS may be referred to as a “user terminal specific reference signal (UE-specific Reference Signal).”

### (Base Station)

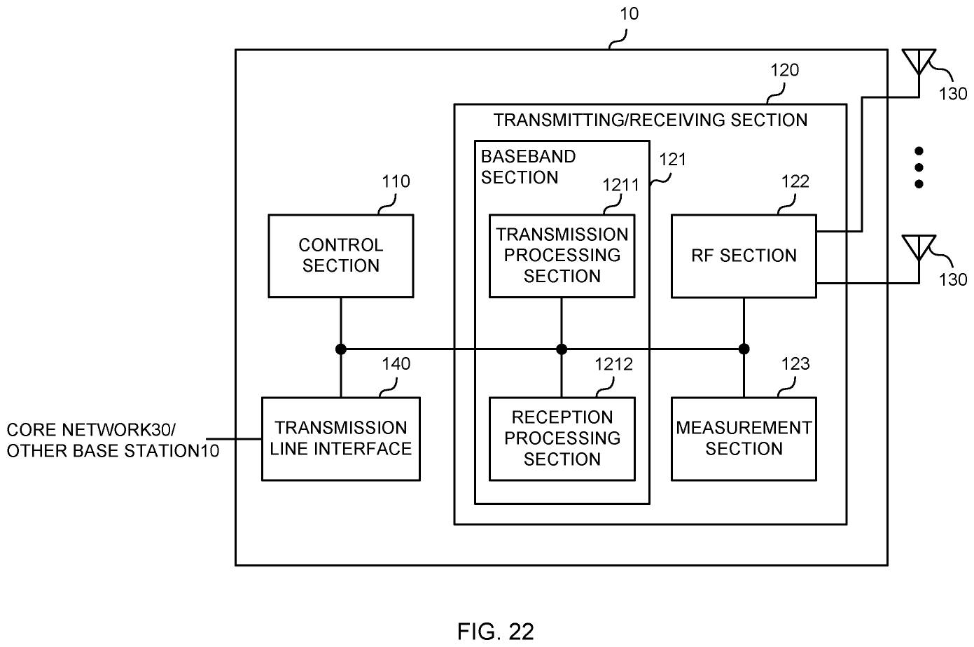

FIG. 22 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

The transmitting/receiving section 120 may receive a CSI report.

The control section 110 may control reception of a CSI report in which mapping order of CSI fields is determined based on at least one of a corresponding transport block (TB) index and TRP index, the CSI report including information related to measurement of a plurality of transmission/reception points (TRPs).

### (User Terminal)

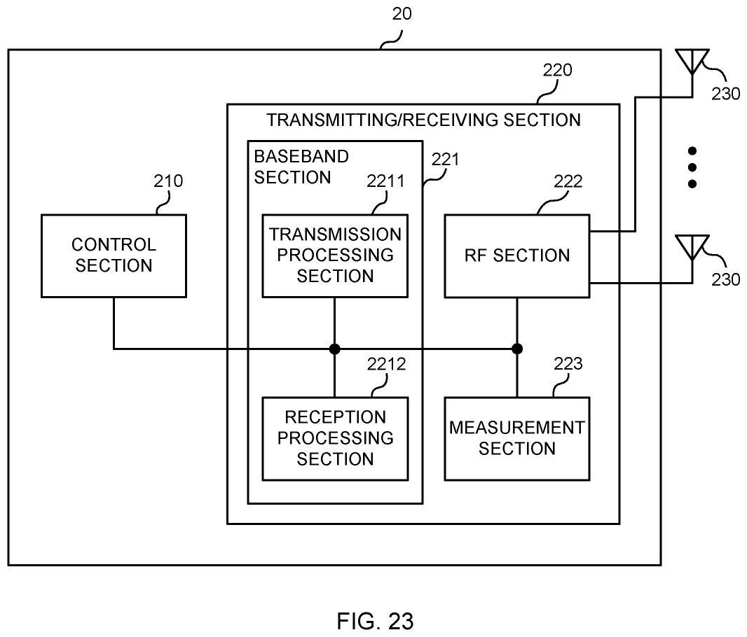

FIG. 23 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DET processing (as necessary), IFFT processing, precoding, digital-to-analog conversion, and so on, on the bit string to transmit, and output a baseband signal.

Note that, whether to apply DET processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may transmit a CSI report.

The control section 210 may control mapping order of CSI fields included in a CSI report including information related to measurement of a plurality of transmission/reception points (TRPs), based on at least one of a substance of a parameter and a corresponding transport block (TB) index or TRP index.

The control section 210 may perform control to map, for each of given parameters included in a CSI report, a first TB or TRP before a second TB or TRP having a large index compared to the first TB or TRP.

The control section 210 may map, regardless of a substance of a given parameter included in the CSI report, a parameter corresponding to the first TB or TRP before a parameter corresponding to the second TB or TRP having a large index compared to the first TB or TRP.

Sharing of a given parameter may be configured for the CSI report for the plurality of TRPs.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

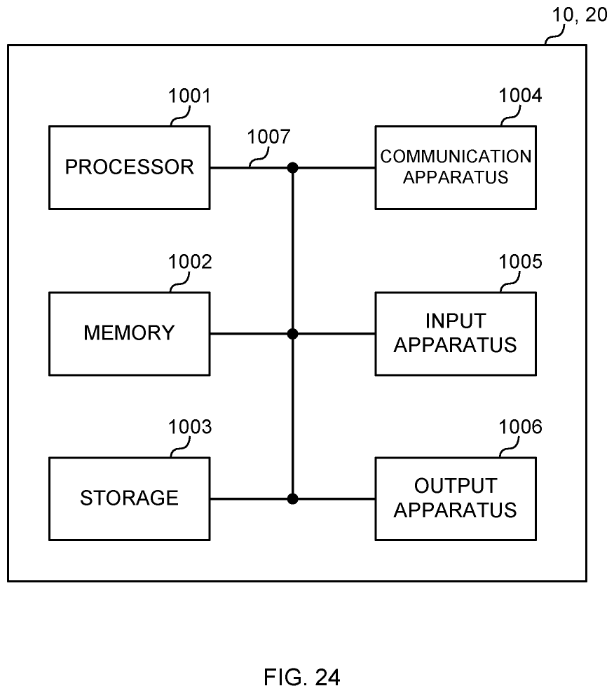

For example, a base station, a user terminal, and so on according to one embodiment of the present disclosure may function as a computer that executes the processes of the radio communication method of the present disclosure. FIG. 24 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given channel/signal outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of given information (for example, reporting of “being X”) does not necessarily have to be reported explicitly, and can be reported implicitly (by, for example, not reporting this given information or notifying another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a control section that controls mapping order of channel state information (CSI) fields included in a CSI report including information related to measurement of a plurality of transmission/reception points (TRPs), based on at least one of a substance of a parameter and a corresponding transport block (TB) index or TRP index; and
a transmitting section that transmits the CSI report.

2. The terminal according to claim 1, wherein
the control section maps, for each of given parameters included in the CSI report, a first TB or TRP before a second TB or TRP having a large index compared to the first TB or TRP.

3. The terminal according to claim 1, wherein
the control section maps, regardless of a substance of a given parameter included in the CSI report, a parameter corresponding to a first TB or TRP before a parameter corresponding to a second TB or TRP having a large index compared to the first TB or TRP.

4. The terminal according to claim 1, wherein
sharing of a given parameter is configured for a CSI report for a plurality of TRPs.

5. A radio communication method for a terminal, the radio communication method comprising:
controlling mapping order of channel state information (CSI) fields included in a CSI report including information related to measurement of a plurality of transmission/reception points (TRPs), based on at least one of a substance of a parameter and a corresponding transport block (TB) index or TRP index; and
transmitting the CSI report.

6. A base station comprising:
a control section that controls reception of a channel state information (CSI) report in which mapping order of CSI fields is determined based on at least one of a corresponding transport block (TB) index and TRP index, the CSI report including information related to measurement of a plurality of transmission/reception points (TRPs); and
a receiving section that receives the CSI report.

7. The terminal according to claim 2, wherein
the control section maps, regardless of a substance of a given parameter included in the CSI report, a parameter corresponding to a first TB or TRP before a parameter corresponding to a second TB or TRP having a large index compared to the first TB or TRP.

8. The terminal according to claim 2, wherein
sharing of a given parameter is configured for a CSI report for a plurality of TRPs.

9. The terminal according to claim 3, wherein
sharing of a given parameter is configured for a CSI report for a plurality of TRPs.
